(19) United States
(12) Patent Application Publication
(10) Pub. No.: US 2015/0248254 A1
(43) Pub. Date: Sep. 3, 2015

(54) COMPUTER SYSTEM AND ACCESS CONTROL METHOD

(71) Applicant: HITACHI, LTD., Tokyo (JP)

(72) Inventors: Naoyuki Matsunaga, Tokyo (JP); Katsutoshi Asaki, Tokyo (JP); Hideo Takahashi, Tokyo (JP); Takato Kusama, Tokyo (JP); Yoshitaka Tokushou, Tokyo (JP)

(21) Appl. No.: 14/427,640

(22) PCT Filed: Mar. 25, 2013
(86) PCT No.: PCT/JP2013/058584

§ 371 Date: Mar. 12, 2015

(51) Int. Cl. G06F 3/06; G06F 12/10

(52) U.S. Cl. CPC G06F 3/0635; G06F 12/1072; G06F 3/0611; G06F 3/0665; G06F 3/0683; G06F 2212/1024; G06F 2212/1056; G06F 2212/152; G06F 2212/657

(57) ABSTRACT

A higher-level apparatus acquires apparatus identification information identifying a physical storage apparatus including physical areas allocated to a virtual volume. The higher-level apparatus may typically be a host such as the one described above, or may be an apparatus (a switch apparatus, for example) interposed between a host and a physical storage apparatus. Based on the apparatus identification information, the higher-level apparatus selects an access path that is connected directly to the physical storage apparatus including the physical areas allocated to the access destination virtual area in the VVOL and does not extend through any other physical storage apparatus. Using the selected access path, the higher-level apparatus transmits an access request designating the address of the access destination virtual area.

### TECHNICAL FIELD

The present invention relates to an access control technique for a virtual logical volume to which physical areas are allocated from physical areas based on physical storage devices in physical storage apparatuses.

### BACKGROUND ART

There is a known technique of operating physical storage apparatuses as one virtual storage apparatus (hereinafter referred to as the “virtual storage apparatus”).

There are cases where a storage pool formed with physical areas (physical storage areas) based on physical storage devices (hereinafter referred to as PDEVs) that are included in physical storage apparatuses and have different access characteristics is constructed in the virtual storage apparatus. The virtual storage apparatus (the respective physical storage apparatuses) provides a host computer (hereinafter referred to as the host) with a virtual logical volume (hereinafter referred to as VVOL) formed with virtual areas (virtual storage areas), and allocates physical areas from the storage pool to a write destination virtual area in accordance with a write operation to be performed on the VVOL (typically a logical volume compliant with the Thin Provisioning technique) by the host (see PTL1, for example).

According to this technique, the host can access all the physical storage apparatuses constituting the virtual storage apparatus with respect to the VVOL provided by the virtual storage apparatus. The pieces of data written in the VVOL are dispersed and stored into the physical storage apparatuses constituting the storage pool. As a result, access paths can be designed to spread to the physical storage apparatuses so that access (write or read operations) in accordance with access requests designating the VVOL will not concentrate in one physical storage apparatus.

For example, PTL1 discloses a technique of sharing a storage pool among hosts. According to this technique, when a physical storage apparatus receives a read request from a host but does not contain the data to be read therein, the physical storage apparatus reads the data to be read from another physical storage apparatus that contains the data to be read, and transmits the read data to the host.

When receiving a write request from a host, a physical storage apparatus selects a physical area to be allocated to the write destination virtual area from among the vacant physical areas of all the physical storage apparatuses sharing the storage pool.

PTL2 discloses an access path control method for realizing higher reliability by selecting a path that is not an access path having error or a possibility of error during a process to access a volume.

### CITATION LIST

### Patent Literature

[PTL1] JP 2006-99748

[PTL2] JP 2006-154880

### SUMMARY OF INVENTION

### Technical Problem

By a technique of forming a virtual storage apparatus based on physical storage apparatuses, a larger storage capacity than the storage capacity of one physical storage apparatus can be used.

However, there are cases where the performance of access to a VVOL from a host is degraded depending on the access path selected by the host.

In a case where there are access paths to be selected, the selection of the access path to be actually used is controlled by multipath management software that is one of the computer programs to be executed in the host, for example. When an application (an application program) in the host issues a request for access to a VVOL, the multipath management software selects one of the access paths to the physical storage apparatuses that provide the VVOL. Depending on the selected access path, either indirect access or direct access is performed. Indirect access is performed to access the physical area allocated to the access destination virtual area via one or more physical storage apparatuses. Direct access is performed to access the physical area allocated to the access destination virtual area without a detour to any physical storage apparatus.

The problem of access performance degradation is critical particularly in a case where a single storage pool is formed with physical storage apparatuses, and is operated by the Thin Provisioning technique. Since the physical storage apparatus from which the page as an allocated physical area is to be allocated is not determined before actual write is performed, it is necessary to select which access path is to be used for each page so as to maintain the performance of page access.

Further, to place the data in a page to a storage tier having higher access performance, the data in the page might be migrated to another storage apparatus after the page is once allocated.

In a system that performs migration on a volume basis, attention needs to be paid to the program that the correspondence relationship between storage apparatuses and allocated pages is changed during a system operation.

The multipath management software does not recognize whether each access path is an access path for direct access, and whether each access path is an access path for indirect access. Therefore, indirect access might be frequently performed at the time of access to the VVOL, resulting in degradation of VVOL access performance.

### Solution to Problem

A higher-level apparatus acquires apparatus identification information identifying a physical storage apparatus including physical areas allocated to a virtual volume. The higher-level apparatus may typically be a host such as the one described above, or may be an apparatus (a switch apparatus, for example) interposed between a host and a physical storage apparatus. Based on the apparatus identification information, the higher-level apparatus selects an access path (or an access path for direct access) that is connected directly to the physical storage apparatus including the physical areas allocated to the access destination virtual area in the VVOL and does not extend through any other physical storage apparatus. Using the selected access path, the higher-level apparatus transmits an access request designating the address of the access destination virtual area.

### Advantageous Effects of Invention

Degradation of VVOL access performance can be reduced.

### BRIEF DESCRIPTION OF DRAWINGS

FIG. 1 is a diagram for explaining an outline of a computer system according to a first embodiment.

FIG. 2 is a diagram for explaining an outline of a process to be performed by the computer system according to the first embodiment.

FIG. 3 is a configuration diagram of the computer system according to the first embodiment.

FIG. 4 is a configuration diagram of a host according to the first embodiment.

FIG. 5 is a configuration diagram of an example of VVOL configuration information according to the first embodiment.

FIG. 6 is a configuration diagram of a physical storage apparatus according to the first embodiment.

FIG. 7 is a configuration diagram of an example of mapping information according to the first embodiment.

FIG. 8 is a configuration diagram of an example of access management information according to the first embodiment.

FIG. 9 is a configuration diagram of an example of VVOL-related information according to the first embodiment.

FIG. 10 is a configuration diagram of a tier definition input screen according to the first embodiment.

FIG. 11 is a flowchart of an access control process according to the first embodiment.

FIG. 12 is a flowchart of a VVOL configuration acquisition process according to the first embodiment.

FIG. 13 is a flowchart of a storage configuration acquisition process according to the first embodiment.

FIG. 14 is a flowchart of a virtual identification process according to the first embodiment.

FIG. 15 is a flowchart of a host access control process according to the first embodiment.

FIG. 16 is a flowchart of a host configuration acquisition process according to the first embodiment.

FIG. 17 is a flowchart of a rearrangement process according to the first embodiment.

### DESCRIPTION OF EMBODIMENTS

The following is a description of embodiments, with reference to the drawings. It should be noted that the embodiment described below do not limit the claimed invention, and the respective components described in the embodiments and all the combinations thereof are not necessarily required in the means to solve the problems.

In the following description, some processes are described as processes to be performed by a “program”. A program is executed by a processor (such as a CPU (Central Processing Unit) to perform a predetermined process by using a storage source (such as a memory) and/or a communication interface apparatus (such as a port). Therefore, processes may be performed by a “processor”. In view of this, the processes described as the processes to be performed by a “program” may be considered to be processes to be performed by a “processor”. A “processor” may include a hardware circuit that performs part or all of the processes to be performed by the processor. A computer program may be installed from a program source into an apparatus. A program source may be a program distribution server or a computer readable storage medium, for example.

### First Embodiment

### Outline of First Embodiment

First, an outline of a computer system according to a first embodiment is described.

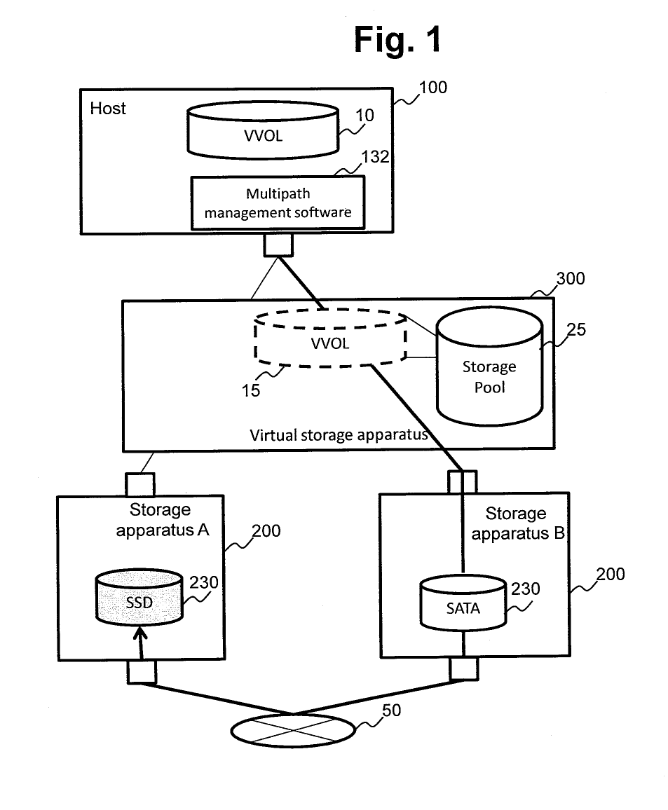

FIG. 1 is a diagram for explaining the outline of the computer system according to the first embodiment.

In the computer system according to the first embodiment, a virtual storage apparatus 300 is formed with physical storage apparatuses 200. A storage pool 25 is formed in the virtual storage apparatus 300. The storage pool 25 is formed with physical areas based on PDEVs 230 included in the physical storage apparatuses 200. The storage pool 25 may be formed with logical volumes, and each of the logical volumes (hereinafter referred to as the pool volumes) constituting the storage pool 25 may be divided into physical areas. The pool volumes may be logical volumes based on a RAID (Redundant Array of Independent Disks) group, or may be logical volumes formed by virtualizing the logical volumes of the storage apparatuses outside the physical storage apparatus.

In this computer system, a physical area is allocated, by the pool 25, to a virtual area of a VVOL 15 to be provided to the host 100. Therefore, there is a possibility that the sets of data written in the VVOL 15 are decentralized and stored into the storage apparatuses 200 constituting the virtual storage apparatus 300.

In the computer system, a multi-path configuration is formed by providing paths between the host 100 that accesses the VVOL and all the physical storage apparatuses 200 constituting the virtual storage apparatus 300. In making access (input/output) to the VVOL, multipath management software 132 to be executed by the host 100 selects which access path is to be used.

Normally, multipath management software does not know which physical storage apparatus 200 actually stores the data in the VVOL 15. Therefore, the multipath management software sometimes selects the access path to a physical storage apparatus 200 that does not store the data to be accessed, and transmits an access request. In such a case, indirect access, or more specifically, a communication using an inter-apparatus path might occur. An inter-apparatus path means a path formed by allocating one of the ports connecting the host and the physical storage apparatuses to communications between the physical storage apparatuses. An inter-apparatus path may be a path that extends via a network, such as a storage area network (SAN).

Specifically, in FIG. 1, if the multipath management software transmits an access request by using the access path to a storage apparatus B so as to access the data stored in the PDEV 230 in a storage apparatus A, for example, the storage apparatus B communicates with the storage apparatus A by using the inter-apparatus path. As a result, access performance deteriorates.

To reduce such situations, in the first embodiment, the host 100 (or the multipath management software 132, for example) acquires and stores information identifying the storage apparatus 200 in which the data in the VVOL is stored, so as to select the access path (a direct access path) through which the physical storage apparatus 200 having the physical area storing the data to be read in the VVOL can be accessed without a detour to another physical storage apparatus 200 at the time of access.

Also, in the computer system, there are cases where a rearrangement process is performed to change the destinations of the data in the VVOL in the pool 25 in accordance with the frequency of access from the host 100. For example, data with high access frequency is placed in a physical area based on a high-speed PDEV 230 (a SSD (Solid State Drive), for example), and data with low access frequency is placed in a physical area based on a low-speed PDEV 230 (a SATA (Serial-ATA), for example).

There is a possibility that the storage apparatus 200 into which the data in the VVOL is to be stored is changed by the rearrangement process. In such a case, even if the multipath management software 132 stores the information identifying the physical storage apparatus 200 that is the storage destination of the data in the VVOL at a certain time point, the information does not necessarily indicate the current situation. Therefore, when access is made, the direct access path to the physical storage apparatus 200 in which the data is stored might not be selected.

In this embodiment, when the storage apparatus 200 in which the data in the VVOL is stored is changed, the change is correctly detected, and the detection result is reflected by the host 100.

An outline of the process is described below.

### <Outline of the Process>

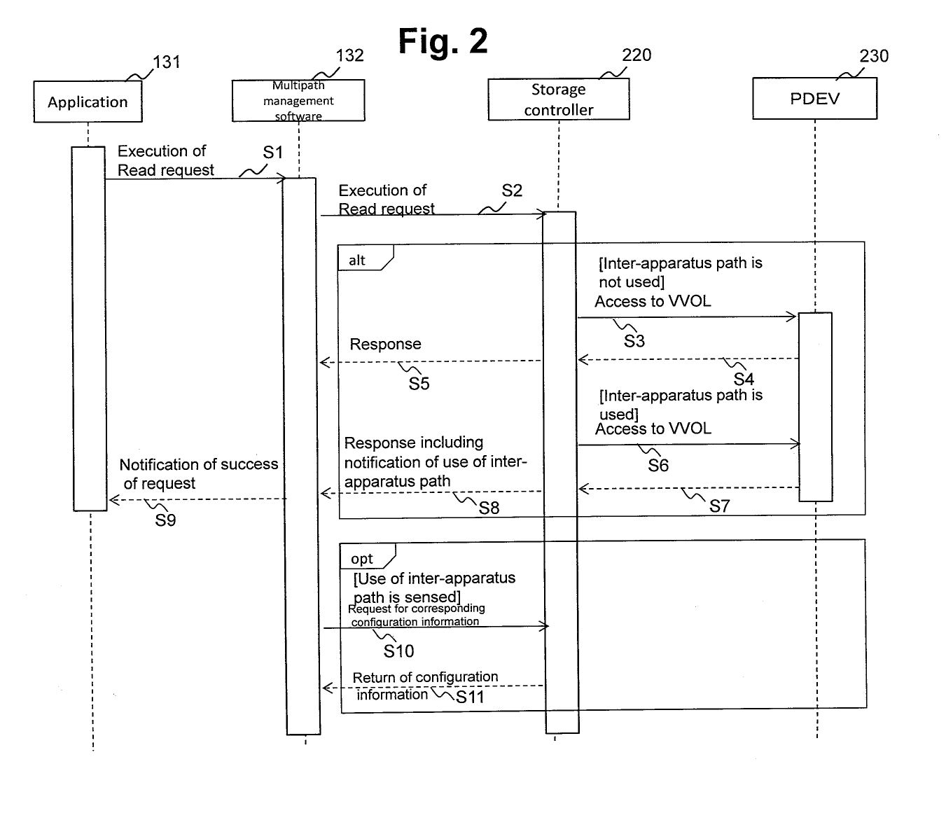

FIG. 2 is a diagram for explaining an outline of the process to be performed by the computer system according to the first embodiment.

FIG. 2 shows an example of a trigger to update the information (VVOL configuration information) identifying the storage apparatus 200 in which the data in the VVOL is stored, so that the multipath management software 132 can minimize occurrences of communications using inter-apparatus paths.

When the application (the application program) 131 of the host 100 issues a read request (step S1), the multipath management software 132 issues a read request in accordance with the above read request to a physical storage apparatus 200 (step S2). The access path used in issuing this request is selected by the multipath management software 132.

When the data to be read is stored in the PDEV 230 in its own physical storage apparatus 200 (when any inter-apparatus is not used), a storage controller 220 (the controller 220 in the physical storage apparatus) accesses the PDEV 230 (step S3). The storage controller 220 reads the data requested by the read request from the PDEV 230 (step S4), and returns a response including the read data to the host 100 (step S5).

When the data to be read is stored in the PDEV 230 in another physical storage apparatus 200 (when an inter-apparatus path needs to be used), the storage controller 220 access the other physical storage apparatus 200 by using an inter-apparatus path (step S6). The data to be read is read from the PDEV 230 of the other physical storage apparatus 200 (step S7), and a response including the read data and a notification indicating the use of the inter-apparatus path (a notification of inter-apparatus path use: an example of difference information) is returned to the host 100 (step S8).

Upon receipt of a response from a physical storage apparatus 200, the multipath management software 132 notifies the application 131 of the success of the request (step S9).

When the response from a storage apparatus 200 contains a notification of inter-apparatus path use, the physical storage apparatus 200 to which the read request is transmitted does not store the data to be read. In this case, the multipath management software 132 transmits a request to acquire the changed and latest VVOL configuration information to a physical storage apparatus 200 (step S10), and receives the VVOL configuration information from the physical storage apparatus 200 (step S11). Based on the received VVOL configuration information, the multipath management software 132 updates the information stored in the host 100. Accordingly, when access is made after this update, there is a higher possibility that a direct access path is selected. In other words, the possibility that an inter-apparatus path communication occurs can be lowered.

Next, the computer system according to the first embodiment is described in detail.

### <Configuration of the Computer System>

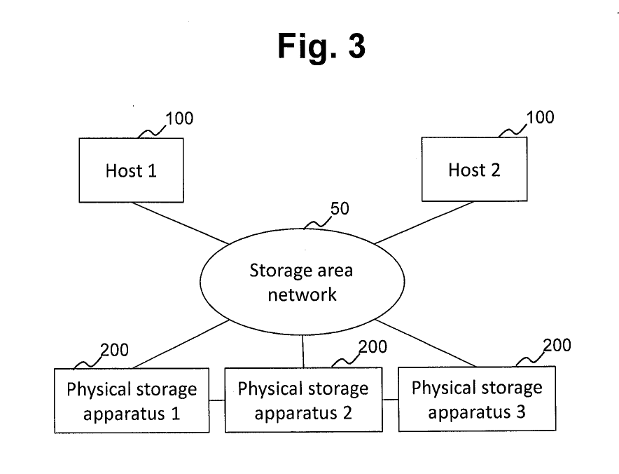

FIG. 3 is a configuration diagram of the computer system according to the first embodiment.

The computer system includes one or more host computers (hosts) 100 and storage apparatuses 200. The hosts 100 are connected to the storage apparatuses 200 via a storage area network (SAN) 50 as an example network.

### <Configuration of a Host>

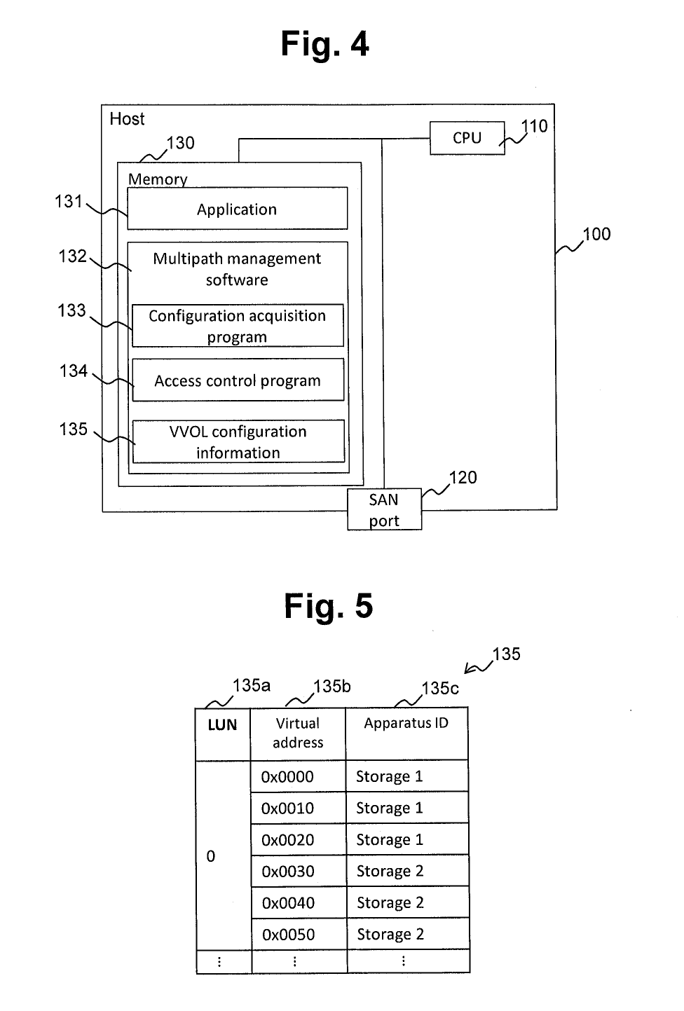

FIG. 4 is a configuration diagram of a host according to the first embodiment.

A host 100 is an example of a higher-level apparatus, and includes a CPU 110, a SAN port 120, and a memory 130. The CPU 110 is connected to the SAN port 120 and the memory 130 via an internal bus. The SAN port 120 is an interface device connected to the storage area network 50. The CPU 110 performs various kinds of processes by executing programs stored in the memory 130.

The memory 130 stores the programs and various kinds of information. The memory 130 stores at least one application program (application) 131 and the multipath management software 132, for example. The application 131 is executed by the CPU 110, so as to transmit an access request (a read/write request) to a physical storage apparatus via the SAN port 120.

The multipath management software 132 determines which access path is to be used in transmitting an access request from the application 131.

The multipath management software 132 includes a configuration acquisition program 133, an access control program 134, and VVOL configuration information 135.

The configuration acquisition program 133 acquires information about storage ports that can be accessed. The configuration acquisition program 133 is executed on a regular basis, for example. The access control program 134 controls access requests from the application 131. Specifically, when transmitting a request to access a VVOL from the application 131, the access control program 134 refers to the VVOL configuration information 135, to determine which path is to be used.

### <VVOL Configuration Information>

FIG. 5 is a configuration diagram of an example of the VVOL configuration information according to the first embodiment.

The VVOL configuration information 135 is information indicating which physical storage apparatus has the PDEV 230 in which the data in the virtual areas in the VVOL is stored, and is an example of storage apparatus identification information. The VVOL configuration information 135 stores entries including fields which are a LUN 135a, a virtual address 135b, and an apparatus ID 135c. In the LUN 135a, the identifiers (LUNs: Logical Unit Numbers) for identifying VVOLs in the hosts 100 are stored. In the virtual address 135b, the addresses of predetermined virtual areas constituting the VVOLs corresponding to the LUNs are stored. In the apparatus ID 135c, the identifiers (apparatus IDs) of the physical storage apparatuses having the physical areas allocated to the virtual areas indicated by the addresses in the virtual address 135b are stored.

The VVOL configuration information 135 is regularly acquired from physical storage apparatuses by the multipath management software 132, for example. Upon receipt of a request to access the virtual areas in a VVOL from the application 131, the multipath management software 132 identifies, based on the VVOL configuration information 135, the apparatus ID of the physical storage apparatus having the physical area allocated to the virtual address of the LUN corresponding to the VVOL indicated by the access request, selects the access path through which the physical storage apparatus with this apparatus ID can be directly accessed, and transmits an access request.

### <Configuration of a Physical Storage Apparatus>

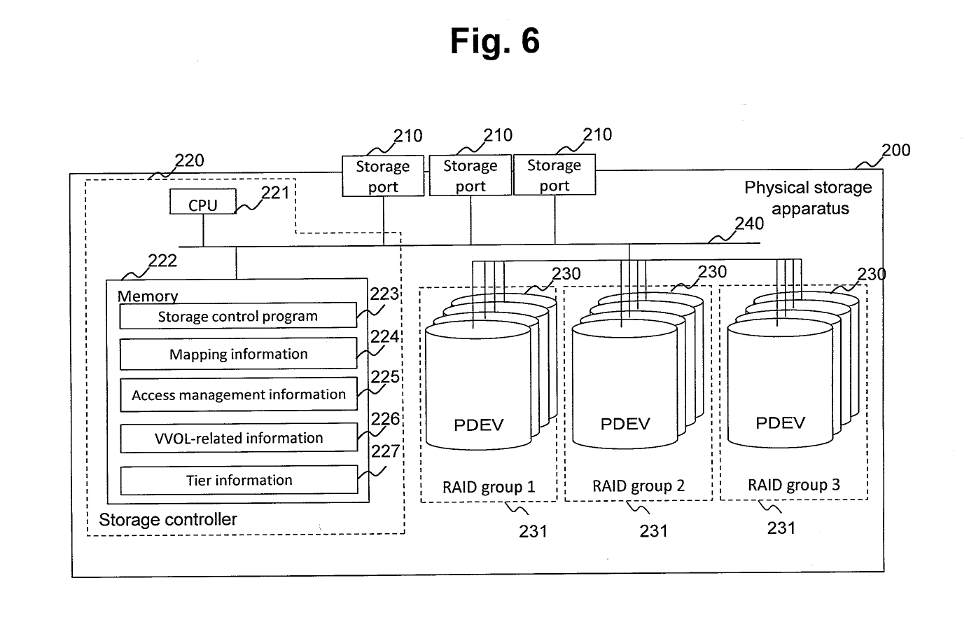

FIG. 6 is a configuration diagram of a physical storage apparatus according to the first embodiment.

The physical storage apparatus includes PDEVs 230, a storage controller 220, one or more storage ports 210, and an internal bus 240. The PDEVs 230, the storage controller 220, and the storage ports 210 are connected via the internal bus 240.

The storage ports 210 are interface devices connected to the SAN 50. The storage ports 210 communicate with the host 100 and other physical storage apparatuses via the SAN 50.

The PDEVs 230 may include more than one kind of PDEVs that have various physical properties such as disk rotation speeds and accordingly, have different performance characteristics. If there are two or more PDEVs 230 of the same type, those PDEVs 230 may constitute a RAID group 231. The physical properties of the PDEVs 230 may vary among the respective physical storage apparatus of the computer system.

The storage controller 220 includes a CPU 221 and a memory 222. The CPU 221 executes a program stored in the memory 222, to perform a predetermined process.

The memory 222 includes a storage control program 223, mapping information 224, access management information 225, VVOL-related information 226, and tier information 227.

The storage control program 223 forms the virtual storage apparatus 300 with physical storage apparatuses.

### <Creation of the Virtual Storage Apparatus>

The storage control program 223 constructs RAID groups 231 from PDEVs 230. After that, the storage control program 223 constructs the storage pool 25 as a virtual pool from one or more RAID groups 231 of each physical storage apparatus.

The VVOL is provided in the host 100 by the storage control program 223. This VVOL is formed with virtual areas. When write is performed on the VVOL, the storage control program 223 allocates a physical area to the write destination virtual area from the storage pool 25. Here, a physical area is a divisional unit that is obtained by dividing the RAID groups 231 constituting the storage pool 25 by a fixed size (1000 blocks, for example). When allocating a physical area, the storage control program 223 notifies all the other physical storage apparatuses constituting the virtual storage apparatus 300 of the ID (address) of the allocated physical area and the virtual address of the allocation destination virtual area. When allocating a new physical area to a VVOL, the storage control program 223 performs control to allocate an unallocated physical area based on the allocation states of the respective physical areas. As a result, physical areas already allocated by a physical storage apparatuses can be prevented from being allocated by the other physical storage apparatuses.

### <Mapping Information>

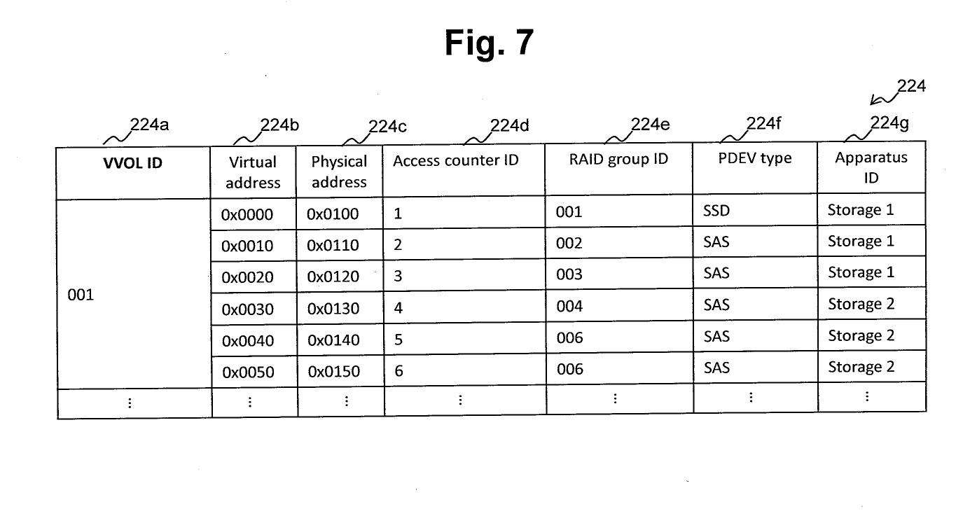

FIG. 7 is a configuration diagram of an example of the mapping information according to the first embodiment.

The mapping information 224 is the information for managing the correspondence relationship between the virtual areas in the VVOL and the physical areas allocated to the virtual areas. The mapping information 224 stores entries including fields which are a VVOL ID 224a, a virtual address 224b, a real address 224c, an access counter ID 224d, a RAID group ID 224e, a device type 224f, and an apparatus ID 224g.

In the VVOL ID 224a, the identifier (VVOL ID) of the VVOL is stored. In the virtual address 224b, the addresses (virtual addresses) corresponding to the virtual areas in the VVOL are stored. In the real address 224c, the addresses (real addresses) of the physical areas allocated to the virtual areas at the virtual addresses in the virtual address 224b are stored. In the access counter ID 224d, the identifiers (access counter IDs) of the counters for managing access to the virtual areas corresponding to the virtual addresses in the virtual address 224b are stored for respective entries. In the RAID group ID 224e, the IDs of the RAID groups to which the PDEVs 230 of the physical areas corresponding to the real addresses in the real address 224c are stored. In the device type 224f, the types of the PDEVs 230 of the physical areas corresponding to the read addresses in the real address 224c are stored. In the apparatus ID 224g, the identifiers of the physical storage apparatuses including the PDEVs 230 of the physical areas corresponding to the real addresses in the real address 224c are stored.

### <Access Management Information>

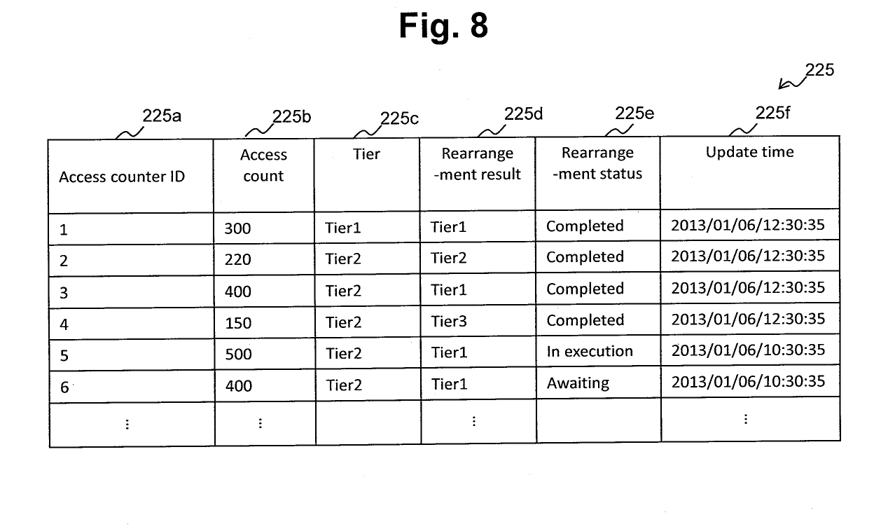

FIG. 8 is a configuration diagram of an example of the access management information according to the first embodiment.

The access management information 225 is the necessary information for rearrangement of the physical areas to be associated with the virtual areas, such as the numbers of accesses to the virtual areas in the VVOL, and stores entries including fields which are an access counter ID 225a, an access number 225b, a current tier 225c, a rearranged tier 225d, a rearrangement status 225e, and an update time 225f.

In the access counter ID 225a, the identifiers (access counter IDs) indicating the entries (referred to as the access counters) in the access management information 225 are stored. In the access number 225b, the numbers of accesses to the virtual areas corresponding to the access counters are stored. In the current tier 225c, the information (tier IDs) indicating the tiers of the physical areas allocated to the virtual areas corresponding to the access counters is stored. In the rearranged tier 225d, the information (tier IDs) indicating the tiers to be allocated to (to be rearranged for) the virtual areas is stored. In the rearrangement status 225e, rearrangement execution states are stored. In the update time 225f, the times at which rearrangement is performed are stored.

### <VVOL-related Information>

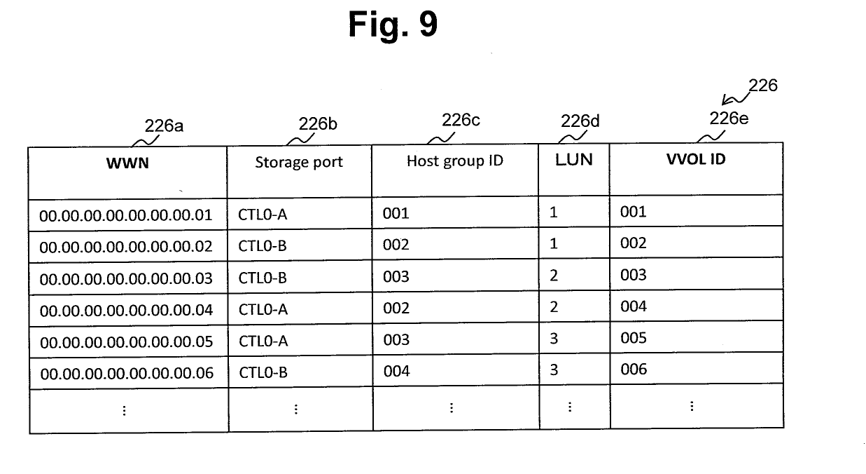

FIG. 9 is a configuration diagram of an example of the VVOL-related information according to the first embodiment.

The VVOL-related information 226 is the information indicating the relationship between the WWNs (World Wide Names) and LUNs of the hosts 100, and the VVOL IDs of access destinations, and includes entries including fields which are a WWN 226a, a storage port 226b, a host group ID 226c, a LUN 226d, and a VVOL ID 226e.

In the WWN 226a, the WWNs of the hosts 100 are stored. In the storage port 226b, the identifiers of the storage ports 210 of the physical storage apparatuses are stored. In the host group ID 226c, the identifiers (host group IDs) of the host groups to which the hosts 100 belong are stored. In the LUN 226d, the identifiers (LUNs) of the VVOLs are stored. In the VVOL ID 226e, the identifiers (VVOL IDs) for the physical storage apparatuses to identify the VVOLs are stored.

### <Tier Information>

The tier information 227 is the information for managing the tiers in the storage pool 25. The tier information 227 contains tier IDs, allowable access ranges, device types, RAID levels, and apparatus IDs. The tier IDs are the IDs for identifying the tiers. In this embodiment, “Tier 1” is the tier with the highest performance, and the performance level becomes lower in the order of “Tier 2” and “Tier 3”. The allowable access ranges each include the minimum value and the maximum value that indicate the range of the number of accesses (the allowable number of accesses) allowed for each unit time in the corresponding tier. The device types include the types of the PDEVs 230 constituting the storage areas constituting the tiers. The RAID levels include the RAID levels of the storage areas constituting the tiers. The apparatus IDs include the IDs of the physical storage apparatuses including the storage areas constituting the tiers.

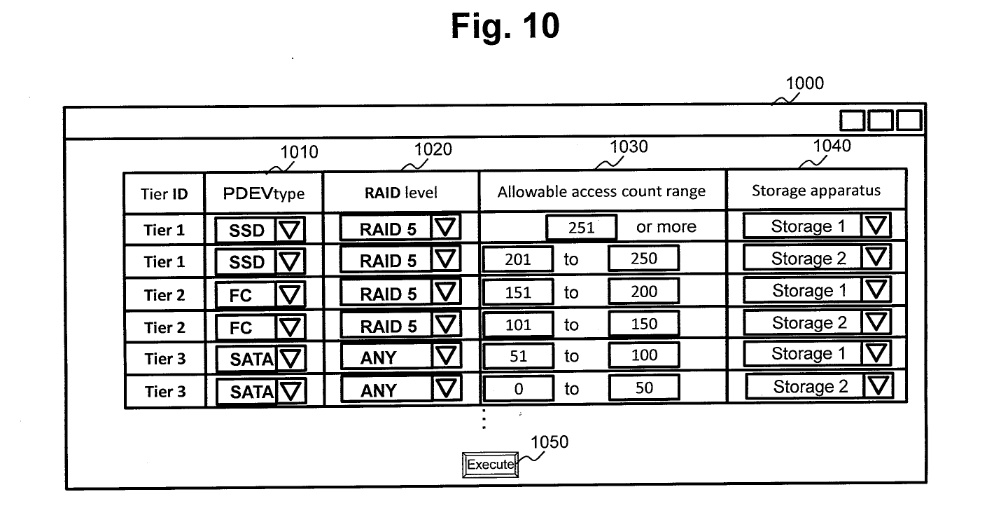

FIG. 10 is a configuration diagram of a tier definition input screen according to the first embodiment.

A tier definition input screen 1000 is a screen to be used for setting the tier information 227, and is displayed on the computer (a host 100 or a management computer that is not shown) being used by the user who sets the tier information, for example.

In the tier definition input screen 1000, a device type setting area 1010, a RAID level setting area 1020, an allowable access number range setting area 1030, a storage apparatus setting area 1040, and a setting execution button 1050 are displayed.

In the device type setting area 1010, the types of the PDEVs 230 constituting the storage areas of the tiers are displayed in a selectable manner. In the RAID level setting area 1020, the RAID levels of the RAID groups constituting the storage areas of the tiers are displayed in a selectable manner. In the allowable access number range setting area 1030, the ranges of the allowable numbers of accesses to the storage areas of the tiers can be set. In the storage apparatus setting area 1040, the IDs of the physical storage apparatuses that provide the storage areas of the tiers are displayed in a selectable manner. The setting execution button 1050 is the button for the user to execute the settings in accordance with the contents that are set in the respective setting areas 1010 through 1040. When the setting execution button 1050 is pressed, the set contents are transmitted to the physical storage apparatuses, tier setting is performed based on the contents, and the tier information 227 is stored.

Next, processing operations to be performed in the computer system according to the first embodiment are described.

### <Access Control Process by a Physical Storage Apparatus>

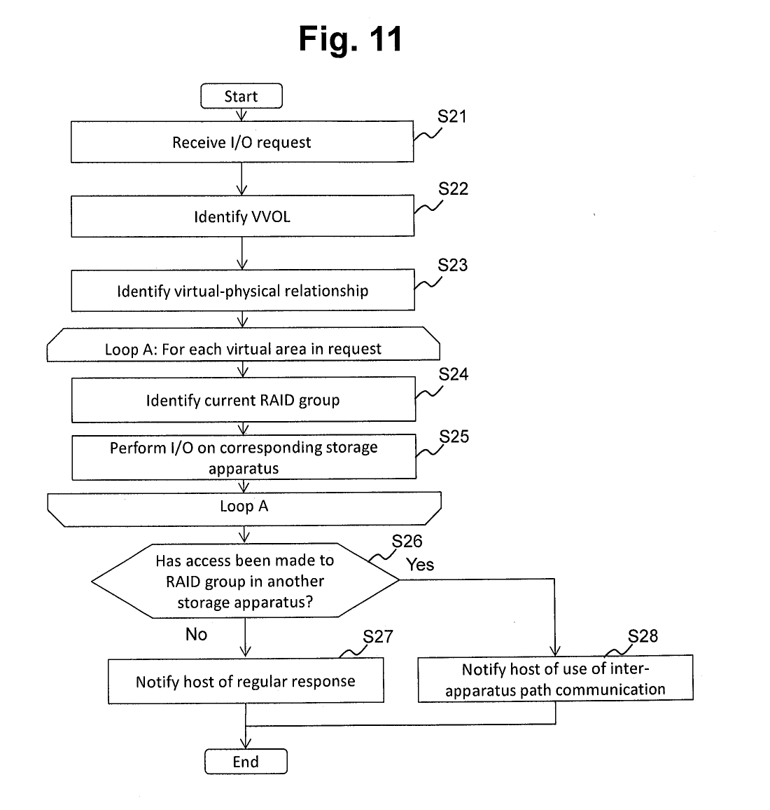

FIG. 11 is a flowchart of an access control process according to the first embodiment.

The access control process is the process to be performed when an access request is received from a host 100.

Upon receipt of an access request from a host 100 (step S21), the storage controller 220 performs a process to identify the access destination VVOL (hereinafter referred to as the target VVOL in this process) (step S22). This access request contains a storage port ID, a LUN, the WWN of the host 100, an access target range, and the likes. Specifically, the storage controller 220 refers to the VVOL-related information 226, and identifies the entry based on the storage port ID, the LUN, and the WWN of the host 100 contained in the access request. In this manner, the VVOL ID is identified.

The storage controller 220 then refers to the mapping information 224, and identifies the entry corresponding to the respective virtual areas in the access target range in the VVOL having the identified VVOL ID (step S23).

The storage controller 220 then performs the process of loop A (steps S24 and S25) for each virtual area. In the process of loop A, the storage controller 220 refers to the entries in the mapping information 224 for the respective virtual areas in the access target range, identifies the apparatus ID of a physical storage apparatus in the RAID group to which the physical areas allocated to the virtual areas belong, and performs an access process on the physical storage apparatus having this apparatus ID. If the access request is made for the first write in a virtual area, the storage controller 220 allocates a physical area to the virtual area, because no physical areas have been allocated to this virtual area. The storage controller 220 then notifies the other physical storage apparatuses of the information about the virtual area and the allocated physical area.

After the process of loop A has been performed for the respective virtual areas, the storage controller 220 determines whether any RAID group of other physical storage apparatuses has been accessed during the process of loop A for the respective virtual areas (step S26).

If the access process has not been performed on any RAID group of other physical storage apparatuses (step S26: No), the access process has been performed without the use of any inter-apparatus path, or the physical areas associated with all the virtual areas exist in its own physical storage apparatus. Therefore, the storage controller 220 transmits a regular response to the host 100 (step S27).

If the access process has been performed on any RAID group of other physical storage apparatuses (step S26: Yes), on the other hand, one of the physical areas associated with the virtual areas exists in another physical storage apparatus, and an inter-apparatus path has been used. Therefore, the storage controller 220 transmits a response including a notification to the effect that an inter-apparatus path communication has been performed, to the host 100 (step S28). As a result, the host 100 can appropriately recognize that an inter-apparatus path has been used.

### <VVOL Configuration Acquisition Process>

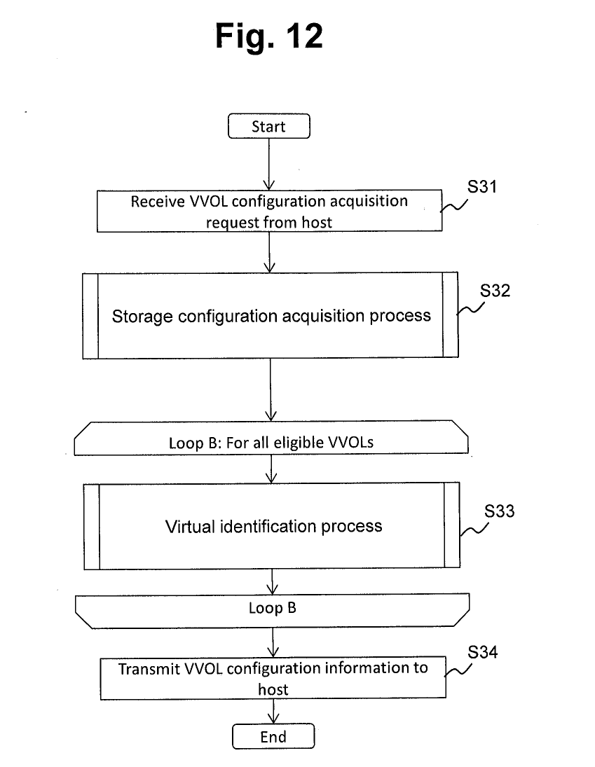

FIG. 12 is a flowchart of a VVOL configuration acquisition process according to the first embodiment.

The VVOL configuration acquisition process is the process to be performed when a physical storage apparatus receives a request for acquisition of VVOL configuration information from a host 100.

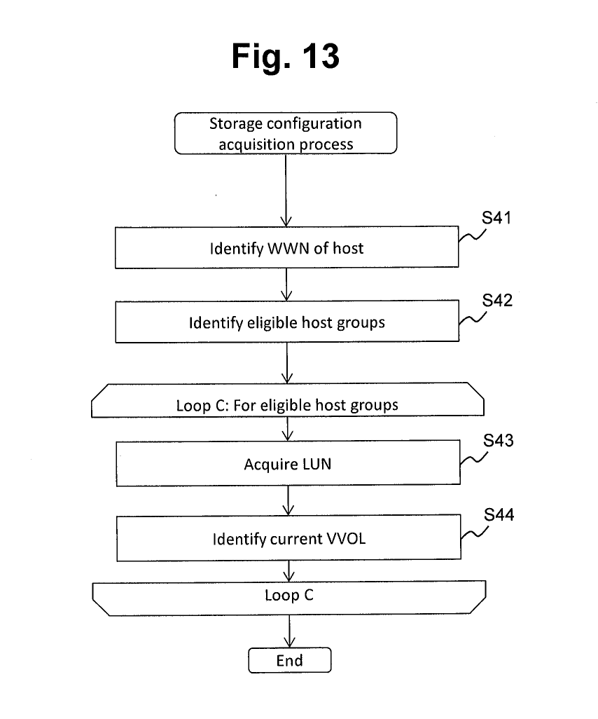

Upon receipt of a request for acquisition of VVOL configuration information from a host 100 (step S31), the storage controller 220 performs a storage configuration acquisition process (see FIG. 13) (step S32). In the storage configuration acquisition process, one or more VVOLs to be used by the host group to which the host 100 belongs are identified.

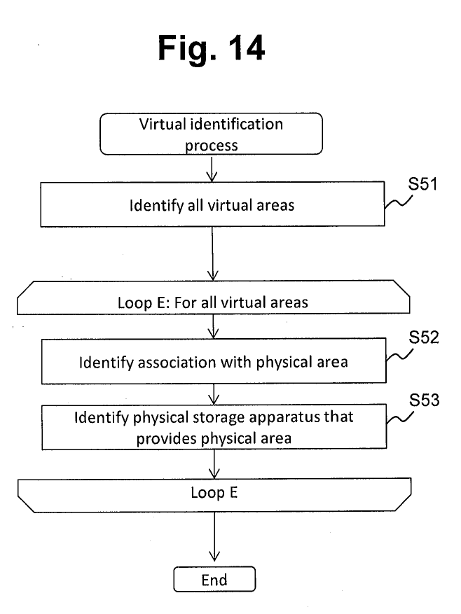

The storage controller 220 then performs the process of loop B (step S33) on all the identified VVOLs. Specifically, the storage controller 220 performs a virtual identification process (see FIG. 14) on each of the VVOLs (step S33). In this virtual identification process, the physical storage apparatuses having the physical areas allocated to the virtual areas of the VVOLs are identified.

After the process of loop B has been completed, the storage controller 220 transmits, to the host 100, the VVOL configuration information indicating the correspondence relationship between the virtual areas and the physical storage apparatuses having the physical areas allocated to the virtual areas (step S34), and then ends the VVOL configuration information acquisition process. When the VVOL configuration information is transmitted, data in a format that collectively shows LUNs, virtual addresses, and apparatus IDs for each VVOL as shown in FIG. 5 may be transmitted, for example.

FIG. 13 is a flowchart of a storage configuration acquisition process according to the first embodiment.

The storage configuration acquisition process corresponds to the process in step S32 in FIG. 12.

The storage controller 220 refers to the VVOL-related information 226, to identify the entry corresponding to the WWN of a host 100 that has transmitted a configuration information acquisition request (step S41). The storage controller 220 then identifies, from the VVOL-related information 226, the entries having the same host group ID as the host group ID in the host group ID 226c of the identified entry (step S42). The storage controller 220 then performs the process of loop C (steps S43 and S44) on all the entries corresponding to the host group having the same host group ID.

In the process of loop C, the storage controller 220 acquires the LUNs from the target entries, and acquires the corresponding VVOL IDs (steps S43 and S44). Through the process of loop C, the VVOL IDs of all the VVOLs to be used in the host group to which the host 100 that has transmitted the configuration information acquisition request can be acquired.

After completing the process of loop C, the storage controller 220 ends the storage configuration acquisition process. The VVOL IDs acquired in this process are the VVOL IDs of the processing target VVOLs in the process of loop B in FIG. 12.

FIG. 14 is a flowchart of a virtual identification process according to the first embodiment.

The virtual identification process corresponds to the process in step S33 in FIG. 12.

The storage controller 220 acquires, from the mapping information 224, the entries with respect to all the virtual areas of processing target VVOLs (step S51). The storage controller 220 then performs the process of loop E (steps S52 and S53) on all the virtual areas corresponding to the acquired entries.

In the process of loop E, the storage controller 220 identifies the physical areas from the entries corresponding to the respective virtual areas as processing targets, identifies the RAID group to which the PDEVs 230 of the physical areas belong, and acquires the apparatus IDs of the physical storage apparatuses constituting the RAID group (steps S52 and S53).

After the process of loop E is performed on all the virtual areas as the processing targets, the virtual identification process is ended.

Through this virtual identification process, the apparatus IDs of the physical storage apparatuses having the physical areas allocated to all the virtual areas in the target VVOLs can be acquired.

### <Access Control Process by a Host 100>

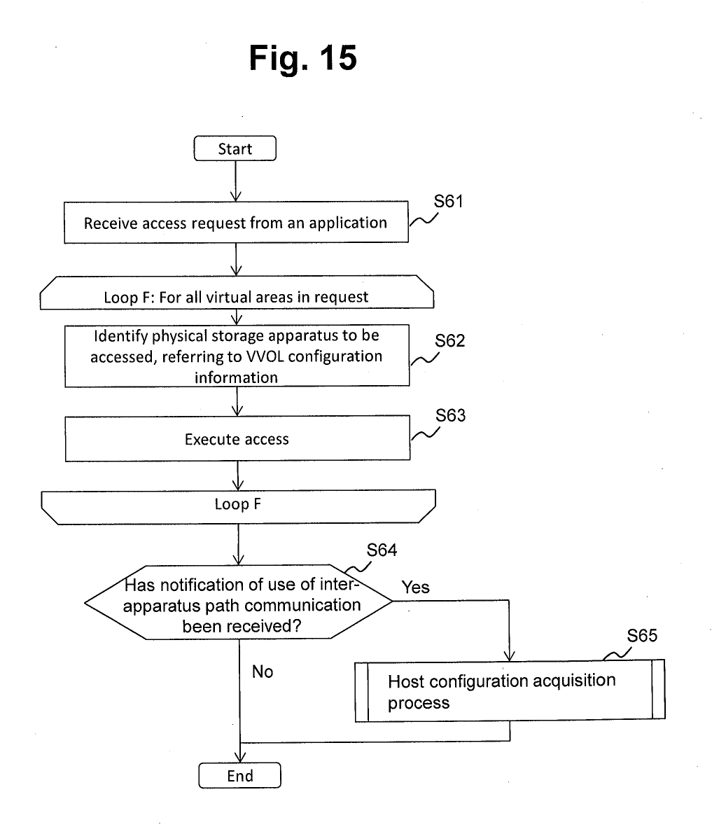

FIG. 15 is a flowchart of a host access control process according to the first embodiment.

The host access control process is performed when the multipath management software 132 receives an access request from an application 131.

Upon receipt of an access request from an application 131 (step S61), the multipath management software 132 performs the process of loop F (steps S62 and S63) on all the target virtual areas designated in the access request.

In loop F, the multipath management software 132 refers to the VVOL configuration information 135, to identify the physical storage apparatus to be accessed (step S62). The multipath management software 132 then transmits an access request by using the direct access path to the identified physical storage apparatus, to perform an access process (step S63). In this manner, an access request is transmitted to the physical storage apparatus having the physical areas allocated to the virtual areas in accordance with the contents of the VVOL configuration information 135, without a detour to another physical storage apparatus. Accordingly, if the physical storage apparatus having the physical areas allocated to the virtual areas in the VVOL has not been changed since the contents of the VVOL configuration information 135 were acquired, an access process is performed in the physical storage apparatus that has received the access request, and any inter-apparatus path communication does not occur.

After performing the process of loop F on all the virtual areas, the multipath management software 132 breaks out of loop F, and determines whether a response indicating the use of an inter-apparatus path communication has been received from the physical storage apparatus (step S64). If a response indicating the use of an inter-apparatus path communication has not been received from the physical storage apparatus (step S64: No), the contents of the VVOL configuration information 135 are still correct at that point of time, and therefore, the host access control process is ended.

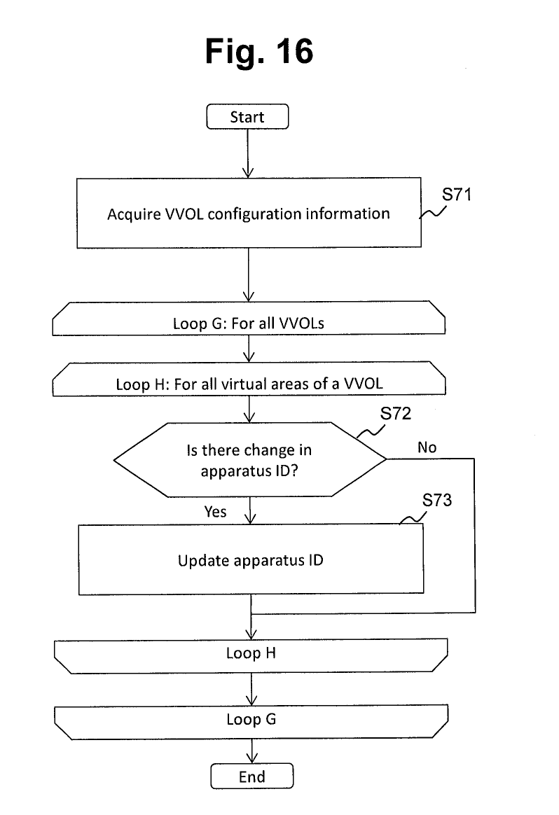

If a response indicating the use of an inter-apparatus path communication has been received from the physical storage apparatus (step S64: Yes), an inter-apparatus path communication has been used, or the contents of the VVOL configuration information 135 are no longer correct at that point of time. Therefore, a host configuration acquisition process (see FIG. 16) is performed to update the VVOL configuration information 135 to the latest contents (step S65). In this manner, incorrect contents of the VVOL configuration information 135 are properly detected in accordance with a response in an actual access process, and the contents of the VVOL configuration information 135 can be promptly and appropriately corrected. The multipath management software 132 then ends the host access control process.

### <Host Configuration Acquisition Process>

FIG. 16 is a flowchart of a host configuration acquisition process according to the first embodiment.

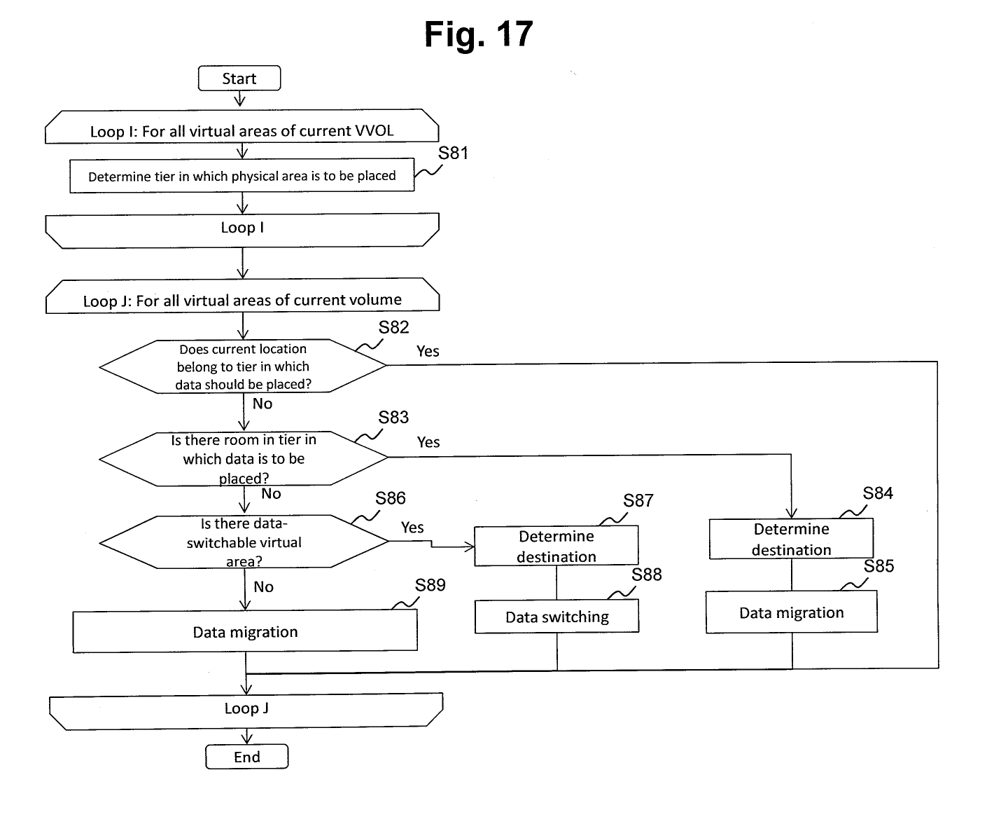

The host configuration acquisition process is the process to be performed by the multipath management software 132 on a regular basis or in step S65 in FIG. 15, for example. The time intervals at which the host configuration acquisition process is regularly performed may be equal to or shorter than the time intervals at which a rearrangement process (see FIG. 17) is performed on the storage pool in a physical storage apparatus. Alternatively, the time intervals at which the host configuration acquisition process is regularly performed may be designated by a user.

The multipath management software 132 transmits a request for acquisition of VVOL configuration information to a physical storage apparatus, and acquires the VVOL configuration information transmitted from the physical storage apparatus (step S71).

The multipath management software 132 then performs the process of loop G (the process of loop H) on all the VVOLs.

In the process of loop G, the multipath management software 132 performs the process of loop H (steps S72 and S73) on all the virtual areas in one VVOL.

In the process of loop H, the multipath management software 132 determines whether there is a change to the apparatus ID corresponding to a virtual area common to the VVOL configuration information 135 stored therein and the VVOL configuration information newly acquired in step S71 (step S72). If there is no change (step S72: No), the next virtual area is set as the processing target. If there is a change (step S72: Yes), the apparatus ID in the VVOL configuration information 135 is updated to the contents of the VVOL configuration information received in step S71 (step S73), and the next virtual area is then set as the processing target.

After performing the process of loop H on all the virtual areas in one VVOL, the multipath management software 132 performs the process of loop H on another VVOL.

After completing the process of loop H on all the VVOLs, the multipath management software 132 breaks out of loop G, and ends the host configuration acquisition process.

Through the host configuration acquisition process, the contents of the VVOL configuration information 135 can be appropriately updated to the latest contents. Accordingly, after the rearrangement process (see FIG. 17) described below is performed in the physical storage apparatus, the contents of the VVOL configuration information 135 can be appropriately updated to the contents subjected to the rearrangement process.

Next, the rearrangement process in a physical storage apparatus is described.

### <Rearrangement Process>

FIG. 17 is a flowchart of a rearrangement process according to the first embodiment.

The rearrangement process is the process to be performed by the storage controller 220 on all the VVOLs being managed by the storage controller 220. The rearrangement process is performed on a regular basis (once every hour, for example).

The storage control program 223 performs the process of loop I (step S81) on all the virtual areas in the processing target VVOL (target volume). Specifically, the storage control program 223 determines whether the tier of a physical area in which the data of a virtual area is currently placed is appropriate, and determines a tier in which a physical area is to be placed for each virtual area (step S81).

More specifically, the storage control program 223 refers to the mapping information 224, to acquire the access counter ID corresponding to a virtual area in the VVOL. Based on the access counter ID, the storage control program 223 refers to the access management information 225, to acquire the corresponding number of accesses.

Based on the device type of the PDEVs 230 in the RAID group to which the physical area allocated to the virtual area belongs, the apparatus ID of the physical storage apparatus to which the physical area belongs, and the RAID group ID of the RAID group, the storage control program 223 acquires, from the tier information 227, the allowable access range in the tier to which the physical area belongs.

The storage control program 223 then determines whether the number of accesses acquired from the access management information 225 is within the allowable access range, to determine whether the current tier of the data of the virtual area is appropriate. If the current tier is appropriate, the storage control program 223 identifies the tier ID of the current tier as the tier ID of the rearrangement destination. If the current tier is not appropriate, the storage control program 223 identifies the tier ID of a tier having the number of accesses within the allowable access range as the tier ID of the tier of the rearrangement destination. After the identification, the storage control program 223 writes the identified tier ID into the rearranged tier 225d in the entry in the access management information 225.

The storage control program 223 then performs the process of loop J (steps S82 through S89) on all the virtual areas in the target volume.

That is, the storage control program 223 determines whether the current rearrangement destination of the data of the processing target virtual area (hereinafter referred to as the target virtual area) is the tier in which the data should be placed (step S82). Specifically, the storage control program 223 identifies the entry corresponding to the physical area allocated to the target virtual area in the access management information 225, and compares the tier ID in the current tier 225c of the entry (the tier ID of the current tier) with the tier ID in the rearranged tier 225d of the entry (the tier ID of the rearrangement destination tier). If the tier ID of the current tier of the target virtual area is the same as the tier ID of the rearrangement destination tier (step S82: Yes), the current tier is appropriate, and data migration from the target virtual area is not necessary. Therefore, the storage control program 223 ends the process for the target virtual area, and sets the next virtual area as the processing target. If the tier ID of the current tier of the target virtual area is not the same as the tier ID of the rearrangement destination tier (step S82: No), the current tier is not appropriate. Therefore, the storage control program 223 advances the process to step S83.

In step S83, the storage control program 223 determines whether there is a vacant physical area in the tier in which the target virtual area is to be placed. Specifically, the storage control program 223 identifies the RAID group corresponding to the tier ID of the rearrangement destination tier (hereinafter referred to as the migration destination RAID group candidate), and determines whether there is a vacant physical area (an unallocated physical area) among all the physical areas in the migration destination RAID group candidate.

If there is an unallocated physical area in the tier in which the target virtual area is to be placed (step S83: Yes), the storage control program 223 advances the process to step S84. If there are no unallocated physical areas in the tier in which the target virtual area is to be placed (step S83: No), on the other hand, the storage control program. 223 advances the process to step S86.

In step S84, the storage control program 223 allocates the existing unallocated physical area as the migration destination physical area of the data of the target virtual area. Specifically, the storage control program 223 updates the allocation state of the physical area (migration origin physical area) currently allocated to the target virtual area to “unallocated”, and updates the allocation state of the migration destination physical area to “allocated”. If there are two or more unallocated physical areas, the storage control program 223 may preferentially allocate a physical area of the same physical storage apparatus as the migration origin physical area, as the migration destination physical area. In this manner, no change is made to the physical storage apparatus in which the physical area to be allocated to the virtual area exists. Accordingly, the use of an inter-apparatus path during an access process can be appropriately prevented.

The storage control program 223 then determines the real address of the migration destination physical area to be the real address in the real address 224c of the entry corresponding to the target virtual area in the mapping information 224, sets values corresponding to the migration destination physical area in the RAID group ID 224e, the device type 224f, and the apparatus ID 224g, and migrates the data stored in the migration origin physical area to the migration destination physical area (step S85). The storage control program 223 then ends the process for the target virtual area, and sets the next virtual area as the processing target.

In step S86, the storage control program 223 determines whether there is a physical area that can switch data with the migration origin physical area. Specifically, the storage control program 223 determines whether there is a switchable physical area by determining whether there is a physical area having the same tier ID as the tier in which the target virtual area is to be placed, in the current tier 225c in the entry corresponding to the physical area in the access management information 225, among the physical areas allocated to the migration destination RAID group candidate. If there is a physical area having the same tier ID as the tier ID of the tier in which the target virtual area is to be placed, or if there is a switchable physical area (step S86: Yes), the storage control program 223 advances the process to step S87. If there are no physical areas having the same tier ID as the tier ID of the tier in which the target virtual area is to be placed, or if there are no switchable physical areas (step S86: No), on the other hand, the storage control program 223 advances the process to step S89.

In step S87, the storage control program 223 allocates the existing switchable physical area as the migration destination physical area for the data of the target virtual area. Specifically, the storage control program 223 determines the real address of the migration destination physical area to be the real address in the real address 224c of the entry corresponding to the target virtual area in the mapping information 224, sets the values corresponding to the migration destination physical area in the RAID group ID 224e, the device type 224f, the apparatus ID 224g, determines the real address of the migration origin physical area to be the real address in the real address 224c of the entry corresponding to the virtual area having the migration destination physical area in the mapping information 224 allocated thereto, and sets the values corresponding to the migration origin physical area in the RAID group ID 224e, the device type 224f, and the apparatus ID 224g. If there are two or more switchable physical areas, the storage control program 223 may preferentially determine the migration destination physical area to be a physical area of the same physical storage apparatus as the migration origin physical area. In this manner, no change is made to the physical storage apparatus in which the physical area allocated to the virtual area exists. Therefore, the use of an inter-apparatus path during an access process can be appropriately prevented.

The storage control program 223 then switches data between the migration origin physical area and the migration destination physical area (step S88). The storage control program 223 then ends the process for the target virtual area, and sets the next virtual area as the processing target. For example, the storage control program 223 switches data between the migration origin physical area and the migration destination physical area in the following manner. Note that it is possible to use an unallocated physical area included in the physical storage apparatus, instead of a cache memory area.

Step 1: The storage control program 223 writes the data of the migration origin physical area into the cache memory area in the memory 222.
Step 2: The storage control program 223 writes the data of the migration destination physical area into the cache memory area in the memory 222.
Step 3: The storage control program 223 writes the data of the migration origin physical area in the cache memory area into the migration destination physical area.
Step 4: The storage control program 223 writes the data of the migration destination physical area in the cache memory area into the migration origin physical area.

In step S89, the storage control program 223 determines the migration destination physical area to be the unallocated physical area in the tier having the performance most similar to the performance of the tier to which data is to be migrated, determines the real address of the migration destination physical area to be the real address in the real address 224c of the entry corresponding to the target virtual area in the mapping information 224, sets the values corresponding to the migration destination physical area in the RAID group ID 224e, the device type 224f, and the apparatus ID 224g, and migrates the data of the migration origin physical area to the migration destination physical area. The storage control program 223 then ends the process for the target virtual area, and sets the next virtual area as the processing target.

In the above described rearrangement process, the physical area allocated to a virtual area is changed, and the physical storage apparatus that actually stores the data of the virtual area might be changed. In the computer system according to this embodiment, however, even if the physical storage apparatus allocated to the virtual area is changed, the change can be appropriately reflected in the VVOL configuration information 135 in the host 100, and the use of an inter-apparatus path during an access process for the data in the virtual area can be reduced.

### Second Embodiment

Next, a computer system according to a second embodiment is described. In the description, the differences from the first embodiment will be mainly described, and the same aspects as the first embodiment will not be described or will be only briefly described (the same applies to the later described third embodiment).

In the virtual identification process according to the first embodiment shown in FIG. 14, the apparatus ID of the physical storage apparatus to which an associated physical area belongs is acquired for all the virtual areas in the target VVOL, and, in step S34 in FIG. 12, the acquired apparatus ID of the physical storage apparatus to which the physical areas associated with the respective virtual areas belong is transmitted.

In the process according to the second embodiment shown in FIG. 14, on the other hand, only the information about the virtual area having a change made to the physical storage apparatus to which the associated physical area belongs is acquired, and only the information about the virtual area having the change is transmitted to the host 100. As a result, the data processing amount in the physical storage apparatus can be reduced, and the amount of data to be transmitted from the physical storage apparatus to the host 100 can also be reduced.

The configuration is described below in detail.

The update time 225f of the access counter corresponding to each entry in the access management information 225 of the physical storage apparatus is used. In this update time 225f, the time when the apparatus ID of the apparatus to which the physical area belongs is changed in the rearrangement process shown in FIG. 17 is stored.

When returning VVOL configuration information to the host 100, the physical storage apparatus also returns the update time of the physical area associated with the virtual area (the value in the update time 225f of the entry corresponding to the virtual area in the access management information 225).

In turn, the host 100 associates the update time received from the physical storage apparatus with the virtual area, and stores the update time. When transmitting a configuration information acquisition request to newly acquire VVOL configuration information, the host 100 incorporates the update time related to the previous acquisition of VVOL configuration information into the configuration information acquisition request, and then transmits the configuration information acquisition request to the physical storage apparatus.

In the processing in steps S52 and S53, the physical storage apparatus compares the update time contained in the configuration information acquisition request received from the host 100 with the update time of the entry in the access management information 225 being managed by the physical storage apparatus. Only when the update time received from the host 100 is earlier than the update time being managed by the physical storage apparatus, is the apparatus ID of the entry selected as a target piece of the configuration information to be transmitted. As a result, only the configuration information that needs changing should be transmitted, and accordingly, the amount of data to be transmitted can be reduced.

### Third Embodiment

Next, a computer system according to a third embodiment is described.

In the third embodiment, the apparatus ID of the physical storage apparatus including corresponding physical areas is returned to the host 100 only for the virtual areas to which physical areas of “Tier 1”, which is a RAID group with high-speed physical properties, are allocated. In this manner, the data processing amount in the physical storage apparatus can be reduced, and the amount of data to be transmitted from the physical storage apparatus to the host 100 can also be reduced. Furthermore, as the amount of data to be transmitted becomes smaller, the data processing amount in the host 100 also becomes smaller.

Specifically, after identifying the target VVOL in step S32 in the process shown in FIG. 12, the storage control program 223 of the physical storage apparatus performs this VVOL virtual identification process (see FIG. 14) for each VVOL. In the process of loop E in this virtual identification process, the storage control program 223 identifies the tier ID of the physical area based on the tier information 227 held by the storage controller 220, from the RAID level corresponding to the configuration source RAID group of the physical area corresponding to the target virtual area, the apparatus ID, and the device type of the PDEVs constituting the RAID group. If the tier ID is “Tier 1”, the apparatus ID of the physical area allocated to this virtual area is set as a piece of the configuration information to be returned to the host 100. If the tier ID is other than “Tier 1”, on the other hand, the apparatus ID of the physical area allocated to this virtual area is excluded from the pieces of the configuration information to be returned to the host 100.

In this manner, the amount of data to be transmitted from the physical storage apparatus to the host 100 can be reduced. A virtual area to which a physical area of Tier 1 is allocated is basically an area that is frequently accessed by the host 100. Therefore, the access performance can be dramatically improved simply by selecting an appropriate direct access path to the physical storage apparatus including the physical area allocated to the virtual area. Although only “Tier 1” is the target tier in the third embodiment, the present invention is not limited to that, and a predetermined number of tiers counted from the highest level may be set as target tiers, for example.

Although embodiments have been described so far, the present invention is not limited to those examples, and various changes may be made to them without departing from the scope of the invention. For example, the higher-level apparatus may not be the host 100, but may be a switch (or a combination of a switch and a host coupled to the switch) that can execute the multipath management software 132.

### REFERENCE SIGNS LIST

100: host computer
200: physical storage apparatus

1. A computer system comprising:
a higher-level apparatus that transmits an access request; and
a plurality of physical storage apparatuses configured to provide the same virtual volume formed with a plurality of virtual areas, include a plurality of physical storage devices on which a plurality of physical areas to be allocated to the virtual volume are based, receive the access request, and access a physical area allocated to an access destination virtual area,
wherein the higher-level apparatus acquires apparatus identification information identifying a physical storage apparatus including a physical area allocated to the virtual volume, and,
wherein, based on the apparatus identification information, the higher-level apparatus selects an access path directly connected to the physical storage apparatus including the storage area allocated to the access destination virtual area in the virtual volume, and transmits an access request designating an address of the access destination virtual area by using the selected access path, the access path not extending through another physical storage apparatus.

2. The computer system according to claim 1,
wherein each of the physical storage apparatuses is configured to
store mapping information indicating a correspondence relationship between the virtual areas and at least one storage apparatus providing the physical areas allocated to the virtual areas, and
when receiving an access request from the higher-level apparatus, access the access destination physical area allocated to the access destination virtual area in accordance with the received access request, and, when the physical storage apparatus including the access destination physical area is not the physical storage apparatus thereof, transmit difference information to the higher-level apparatus, the difference information indicating that the storage apparatus thereof does not include the physical area allocated to the access destination virtual area, and,
wherein the higher-level apparatus is configured to acquire, when receiving the difference information, the apparatus identification information identifying the storage apparatus including the storage area allocated to the access destination virtual area.

3. The computer system according to claim 2,
wherein each of the physical storage apparatuses is configured to transmit, when receiving an access request from the higher-level apparatus, a response to the access request, and
wherein each of at least one of the physical storage apparatuses is configured to transmit the difference information incorporated into the response.

4. The computer system according to claim 1,
wherein the respective physical areas are classified into a plurality of tiers in accordance with differences in access characteristics of the physical storage devices on which the physical areas are based, and,
wherein each of at least one of the physical storage apparatuses is configured to transmit, in response to a request from the higher-level apparatus, information identifying a physical storage apparatus including an allocated physical area to the higher-level apparatus only for a virtual area to which the physical area belonging to a predetermined tier is allocated among the virtual areas.

5. The computer system according to claim 4, wherein the predetermined tier is the tier having the highest performance among the plurality of tiers.

6. The computer system according to claim 1, wherein each of the physical storage apparatus is configured to transmit, to the higher-level apparatus, the apparatus identification information identifying physical areas allocated to virtual areas of a plurality of virtual volumes to be provided to the higher-level apparatus.

7. The computer system according to claim 1, wherein the higher-level apparatus is configured to acquire the apparatus identification information at predetermined time intervals.

8. The computer system according to claim 1, wherein each of at least one of the physical storage apparatuses is configured to transmit the apparatus identification information to the higher-level apparatus only with respect to a virtual area for which the physical storage apparatus including a physical area to be allocated after a time when the higher-level apparatus acquires the apparatus identification information is changed.

9. An access control method that is a method of controlling access to a plurality of physical storage apparatuses that provide a higher-level apparatus with the same virtual volume formed with a plurality of virtual areas, include a plurality of physical storage devices on which a plurality of physical areas to be allocated to the virtual volume are based, receive an access request from the higher-level apparatus, and access a physical area allocated to an access destination virtual area,
the access control method comprising:
by the higher-level apparatus, acquiring apparatus identification information identifying a physical storage apparatus including a physical area allocated to a virtual area in the virtual volume, and,
by the higher-level apparatus, selecting an access path directly connected to the physical storage apparatus including an access destination physical area allocated to the access destination virtual area, based on the apparatus identification information, and, by the higher-level apparatus, transmitting an access request designating an address of the access destination virtual area by using the selected access path, the access path not extending through another physical storage apparatus, the higher-level apparatus selecting the access path and transmitting the access request.

10. The access control method according to claim 9,
wherein each of the physical storage apparatuses is configured to
store mapping information indicating a correspondence relationship between the virtual areas and at least one storage apparatus providing the physical areas allocated to the virtual areas, and
when receiving an access request from the higher-level apparatus, accesse the access destination physical area allocated to the access destination virtual area in accordance with the received access request, and, when the physical storage apparatus including the access destination physical area is not the physical storage apparatus thereof, transmit difference information to the higher-level apparatus, the difference information indicating that the storage apparatus thereof does not include the physical area allocated to the access destination virtual area, and,
the access control method comprising
acquiring, by the higher-level apparatus, when receiving the difference information, the apparatus identification information identifying the storage apparatus including the storage area allocated to the access destination virtual area.

11. The access control method according to claim 10,
wherein each of the physical storage apparatuses is configured to transmit, when receiving an access request from the higher-level apparatus, a response to the access request,
the access control method comprising
receiving, by the higher-level apparatus, the response containing the difference information from at least one of the physical storage apparatuses.

12. The access control method according to claim 9,
wherein the respective physical areas are classified into a plurality of tiers in accordance with differences in access characteristics of the physical storage devices on which the physical areas are based,
the access control method comprising
receiving, by the higher-level apparatus, the apparatus identification information from at least one of the physical storage apparatuses, the apparatus identification information only identifying a physical storage apparatus including a physical area allocated to a virtual area to which the physical area belonging to a predetermined tier is allocated among the virtual areas.

13. The access control method according to claim 12, wherein the predetermined tier is the tier having the highest performance among the plurality of tiers.

14. The access control method according to claim 9, comprising
receiving, by the higher-level apparatus, from each of the physical storage apparatuses, the apparatus identification information identifying physical areas allocated to virtual areas of a plurality of virtual volumes to be provided to the higher-level apparatus.

15. The access control method according to claim 9, comprising
receiving, by the higher-level apparatus, from at least one of the physical storage apparatuses, the apparatus identification information only with respect to a virtual area for which the physical storage apparatus including a physical area to be allocated after a time when the higher-level apparatus acquires the apparatus identification information is changed.
